(19) United States
(12) Patent Application Publication
(10) Pub. No.: US 2006/0108167 A1
(43) Pub. Date: May 25, 2006

(54) Apparatus and method to encourage seat belt use

(76) Inventor: Brian Finger, Houston, TX (US)

Correspondence Address: LAW FIRM OF INDRANIL CHOWHURY, P.C, 4800 SUGAR GROVE BLVD SUITE 290, STAFFORD, TX, 77477, US

(21) Appl. No.: 11/168,701

(22) Filed: Jun. 28, 2005

Related U.S. Application Data
(60) Provisional application No. 60/583,021, filed on Jun. 28, 2004.

(51) Int. Cl. B60R 21/00

(52) U.S. Cl. 180/268

(57) ABSTRACT

An apparatus and method for encouraging seat belt use in a vehicle. The apparatus includes a control unit coupled to at least one seat unit and an entertainment unit. If sensors within one of the seat units detect that a seat is occupied and the user in the seat is not wearing a seat belt, the control unit may reduce the functionality of the entertainment unit. The entertainment unit may contain a CD player, radio, or any electronic device unnecessary for operation of the vehicle. The vehicle may not start if a seat unit is occupied and the user in the seat is not wearing a seat belt. In some embodiments of the invention, a temperature control unit may control the temperature within the vehicle if a user is not wearing a seat belt. A child seat unit is described to function with the seat belt encouragement system.

This application claims priority under 35 USC §119(e)(1) of Provisional Application No. 60/583,021, filed Jun. 28, 2004, incorporated herein by reference.

### TECHNICAL FIELD OF THE INVENTION

The present invention relates to a passenger restraint system in a vehicle. More particularly, the invention relates to a system that encourages passengers to use restraint devices in a vehicle. Still more particularly, the invention relates to a system that encourages passengers to use restraint devices by controlling comfort and entertainment features in a vehicle.

### BACKGROUND OF THE INVENTION

Restraint devices such as seat belts may protect vehicle passengers in the event of a sudden stop or accident. These safety devices may save passenger lives and limit the severity of injury when a vehicle accident occurs. However, many people do not use their seat belts regularly. People may not wear their seat belts because they are only driving a short distance, they find seat belts uncomfortable, or they habitually refrain from using seat belts.

Consequently, many techniques and devices are used to encourage seat belt use. In a vehicle, seat belt warning lights may flash or a warning chime may sound to remind the driver and passengers to fasten their seat belts. Laws requiring passengers in a vehicle to use their seat belts are frequently enforced, and violations may carry stiff penalties.

Despite such efforts, many drivers and passengers still refuse to wear seat belts when driving or riding in a vehicle. The abovementioned strategies for encouraging seat belt use are not effective for drivers and passengers who refuse to wear seat belts. Thus, there is a need for an apparatus and method to encourage drivers and passengers to wear seat belts.

### SUMMARY OF THE INVENTION

The problems noted above are solved by an apparatus and method for encouraging use of a restraint device in a vehicle. A control unit couples to at least one seat unit and a comfort unit. The control unit may be capable of controlling the functionality of the comfort unit. In some embodiments of the invention, the control unit may couple to the comfort unit and at least one seat unit through a databus connection.

The seat unit may contain a device for sitting attached to the vehicle, a restraint device attached to the vehicle, and a receiving device attached to the vehicle. The restraint device is capable of attaching to the receiving device. A restraint sensor may be attached to the restraint device and may indicate to the control unit if the restraint device is detached from the receiving device. The control unit may allow the comfort unit to function normally if the restraint device of the seat unit is attached to the receiving device of the seat unit. The vehicle is allowed to start if the seat unit is occupied and the restraint device of the seat unit is attached to the receiving device of the seat unit.

In some embodiments of the invention, the comfort unit may be a temperature control unit capable of adjusting the temperature inside of the vehicle. The comfort unit may adjust the temperature inside the vehicle to a level uncomfortable to a human being if a seat unit is occupied and the restraint device of the seat unit is not attached to the receiving device.

In some other embodiments of the invention, the comfort unit may be an entertainment unit. The entertainment unit may contain a stereo, a radio, a tape player, a CD player, an MP3 player, an MP3 CD player, a DVD player, a display monitor, multiple display monitors, a speaker, multiple speakers, a navigation system, a computer, or a video game device. The functionality of the entertainment unit may be limited by muting the entertainment unit if the seat unit is occupied and the restrain device of the seat unit is not attached to the receiving device.

The device for sitting may be a seat, captain's chair, bucket seat, or a bench seat. The restraint device may be a seat belt, and the receiving device may be a seat belt buckle. The seat unit may further contain a seat sensor attached to the device for sitting. The seat sensor further couples to the control unit and may indicate if the device for sitting is occupied.

In some embodiments of the invention, the seat sensor may be a pushbutton switch that is normally in an open state if the device for sitting is not occupied. The seat sensor may further couple to the restraint sensor. The restraint sensor may be a tension switch that is normally in a closed state if the restraint device is detached from the receiving device. The seat sensor may also couple to the terminal of a battery.

The seat sensor closes when the sitting device is occupied and the tension switch opens when the restraint device attaches to the receiving device. Thus, the seat unit only connects the control unit to the terminal of the battery if the sitting device is occupied and the restraint device is detached from the receiving device.

In some embodiments of the invention, the vehicle may not start if one of the seat units is occupied and the restraint device of the seat unit is not attached to the receiving device. However, the vehicle may start if a drivers seat unit is unoccupied. Thus, the vehicle may be started in emergency situations or if a vehicle engine needs to be warmed. Additionally, the comfort unit may function normally if the vehicle is in accessory mode.

A hood device attaches to the vehicle. A hood status unit couples to the control unit and may indicate to the control unit if the hood device is raised. A starter unit also couples to the control unit. The starter unit is capable of allowing the vehicle to start. The control unit may allow the vehicle to start if the hood device is raised.

A key status sensor couples to the control unit. The key status sensor may indicate to the control module if a key is used for vehicle ignition. If a key is used for accessory mode, the control unit may allow the comfort unit normal functionality.

The control unit may contain a first relay unit coupled to a negative terminal of a battery, the entertainment unit, a positive terminal of a battery, at least one seat unit, and a second relay unit. The second relay unit couples to at least one seat unit, the key status sensor, and the negative terminal of the battery.

The seat unit, in accordance with some embodiments of the invention, may be a child seat unit containing a child sitting device attached to a receiving device and a child restraint device. The child restraint device is capable of attaching to the receiving device. A restraint sensor attaches to the child restraint device and may detect if the child restraint device is detached from the receiving device. A child seat sensor attaches to the child sitting device and may detect if the child sitting device is occupied. The child seat unit further contains a system interface device capable of communicating with the control unit. The child seat unit may communicate to the control unit if the child sitting device is occupied and the child restraint device is detached from the receiving device.

### BRIEF DESCRIPTION OF THE DRAWINGS

FIG. 1, in accordance with some embodiments of the invention, shows a seat unit including a sitting device, restraint device, and a restraint device buckle;

FIG. 2, in accordance with some embodiments of the invention, shows a control unit coupled to a seat unit and an entertainment unit;

FIG. 3 is a flowchart showing interaction between the control unit, seat unit, and entertainment unit;

FIG. 4 shows, in accordance with some other embodiments of the invention, the seat unit of FIG. 1 including a seat, seat belt, seat sensor, and seatbelt buckle;

FIG. 5, in accordance with some embodiments of the invention, shows a control unit coupled to a seat unit, stereo unit, key status sensor, and starter unit;

FIG. 6 is a flowchart showing interaction between the control unit, seat unit, starter unit, key status sensor unit, and stereo unit;

FIG. 7, in accordance with some embodiments of the invention, shows seat unit circuitry including a ground connection, seat sensor, seat belt sensor, and seat unit output;

FIG. 8, in accordance with some embodiments of the invention, shows a control unit coupled to various peripheral units;

FIG. 9, in accordance with some embodiments of the invention, shows circuitry of a control unit including two relay units and a plurality of diodes;

FIG. 10, in accordance with some embodiments of the invention, shows an automobile system containing a control unit coupled to a hood status unit, starter unit, stereo unit, key status sensor, and a plurality of seat units;

FIG. 11, in accordance with some embodiments of the invention, shows a control unit coupled to a seat unit, starter unit, key status sensor unit, and a temperature control unit;

FIG. 12, in accordance with some embodiments of the invention, shows a child seat unit containing a child sitting device, child restraint device, and child restraint device buckle.

### Notation and Nomenclature

Certain terms are used throughout the following description and claims to refer to particular system components and configurations. As one skilled in the art will appreciate, the companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” Also, the terms “couple,” “couples,” or “coupling” are intended to mean either an indirect or direct electrical connection. Thus, if a first device couples to a second device, that connection may be through a direct electrical connection or though an indirect electrical connection via other devices and connections. Further, the term “attach” or “attaches” is intended to mean either an indirect or direct physical connection. Thus, if a first component is attached to a second component, that connection may be through a direct physical connection or through an indirect physical connection via other components and connections.

### DETAILED DESCRIPTION OF EMBODIMENTS

In accordance with some embodiments of the invention, in a vehicle, a control unit couples to at least one seat unit and an entertainment unit. Each seat unit activates a signal to the control unit if the seat unit is occupied and a seat belt is not securely fastened. The control unit may limit functionality of the entertainment unit. For example, if the entertainment unit includes a compact disk (CD) player, the control unit may mute the CD player if one of the seat units is occupied and the seat belt of the seat unit is not securely fastened. The control unit may return functionality to the entertainment unit once the seat belt is securely fastened.

In some embodiments of the invention, a key status sensor and a starter unit couple to the control unit. The control unit may prohibit the vehicle from starting unless the seat belts of all occupied seat units are fastened. Once the vehicle starts, the control unit may limit functionality of the entertainment unit if the seat belt of an occupied seat unit becomes unfastened. Thus, vehicle drivers and passengers may be encouraged to wear seat belts in order to access vehicle entertainment features.

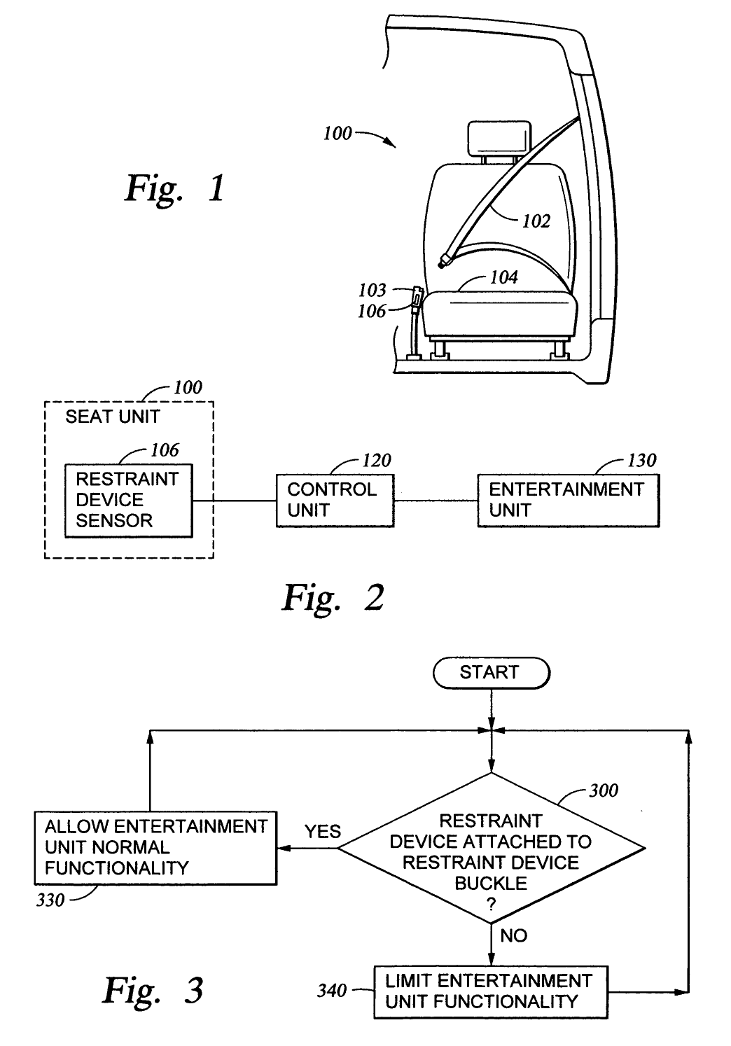

Referring to FIG. 1, a seat unit 100 contains a restraint device 102 capable of extending across a sitting device 104. Sitting device 104 may consist of a seat, a captain's chair, a bench seat, or any other type of device used for sitting in a vehicle. Restraint device 102 may be a lap belt, single belt seat belt, double belt seat belt, seat belt with a shoulder strap, or any type of device used to restrain a passenger, animal, or cargo in a vehicle. Restraint device 102, a restraint device buckle 103, and sitting device 104 may be attached to a vehicle through an attachment device (not shown).

Restraint device 102 is capable of attaching to restraint device buckle 103 to securely restrain a passenger, animal, or cargo occupying sitting device 104. A restraint device sensor 106 may attach to restraint device buckle 103. Restraint device sensor 106 may, for example, be a contact switch, tension sensor, or any device capable of detecting if restraint device 102 attaches to restraint device buckle 103.

Referring to FIG. 2, a control unit 120 couples to seat unit 100 and an entertainment unit 130. Restraint device sensor 106 couples to control unit 120. Control unit 120 may consist of a collection of logic devices, a microcontroller, a circuit, a digital signal processor, a computing device, a collection of relays, or any combination of the aforementioned devices. Entertainment unit 130 may consist of a stereo, radio, tape player, CD player, MP3 player, MP3 CD player, DVD player, display monitor, speakers, navigation system, computer, video game device, any electronic device used for nonessential functions in a vehicle, or any combination of the aforementioned devices. Nonessential functions may include any function within the vehicle not necessary for safe operation of the vehicle.

The components shown in FIG. 2 may couple together through analog, digital, or a combination of analog and digital means. For example, control unit 120 may communicate with entertainment unit 130 through analog signals sent through a single wire or multiple wires or through coded digital signals sent through a databus link. The databus link may be a bus capable of transferring information from control unit 120 to entertainment unit 130.

Turning now to FIG. 3, a flowchart depicting the interaction between control unit 120, seat unit 100, and entertainment unit 130 is shown. As shown in block 300, restraint device sensor 106 may indicate to control unit 120 if restraint device 106 attaches to restraint device buckle 103. If restraint device 102 attaches to restraint device buckle 103, control unit 120 allows entertainment unit 130 normal functionality as shown in block 330. If restraint device 102 does not attach to restraint device buckle 103, control unit 120 may limit entertainment unit 130 functionality as shown in block 340. Control unit 120 in block 300 periodically checks if restraint device 102 attaches to restraint device buckle 103 and performs the appropriate action on entertainment unit 130 as described above.

If a vehicle contains the system shown in FIG. 2, restraint device 102 may be a seat belt and entertainment unit 130 may be a radio. If a passenger in the vehicle is not wearing a seat belt, control unit 120 may mute the radio. If the passenger attaches the seat belt to a seat belt buckle, control unit 120 may allow the radio to function normally. If the passenger removes the seat belt from the seat belt buckle, control unit 120 may again mute the radio, thereby encouraging the passenger to wear the seat belt.

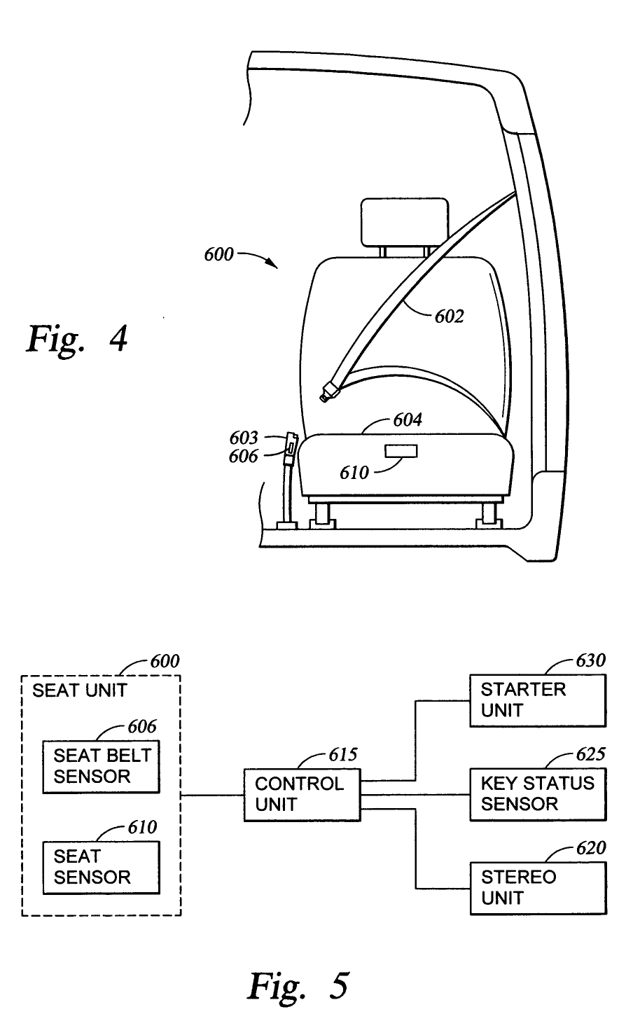

FIG. 4 shows another embodiment of the seat unit of FIG. 1. Seat unit 600 includes a seat belt 602 capable of extending across a seat 604. Seat 604 may be a seat, captain's chair, bench seat, a bucket seat, or any other type of device used for sitting in a vehicle. Seat Belt 602 may be a lap belt, single belt seat belt, double belt seat belt, seat belt with a shoulder strap, or any type of device used to restrain a passenger, animal, or cargo in a vehicle. The seat belt buckle 603, seat 604, and seat belt 602 may be attached to a vehicle through an attachment device (not shown).

Seat belt 602 is capable of attaching to seat belt buckle 603 to securely restrain a passenger, an animal, or cargo in seat 604. A seat belt sensor 606 may attach to seat belt buckle 603 and may be a switch, tension sensor, or any device capable of detecting if seat belt 602 attaches to seat belt buckle 603. A seat sensor 610 may attach to seat 604 and may detect if seat 604 is occupied. Seat sensor 610 may be a pushbutton switch, a pressure sensor, or any device that may detect if seat 604 is occupied.

In accordance with some embodiments of the invention, FIG. 5 shows control unit 615 coupled to seat unit 600, a starter unit 630, a key status sensor 625, and stereo unit 620. Starter unit 630 may be any device capable of starting a vehicle. Stereo unit 620 may be any device capable of reproducing sound, such as a radio or a CD player, and key status sensor 625 may be any device that detects the presence of a key in a vehicle ignition system. Key status sensor 625 may, for example, detect if a key has been placed in an ignition device in the vehicle, if a key is in ignition position in the ignition device, or if a key is in accessory position in the ignition device.

The components of the system shown in FIG. 5 may couple together through analog, digital, or a combination of analog and digital means. For example, control unit 615 may communicate with seat unit 600, starter unit 630, key status sensor 625, and stereo unit 620 through analog signals sent through a single wire or multiple wires or through coded digital signals sent through a databus link.

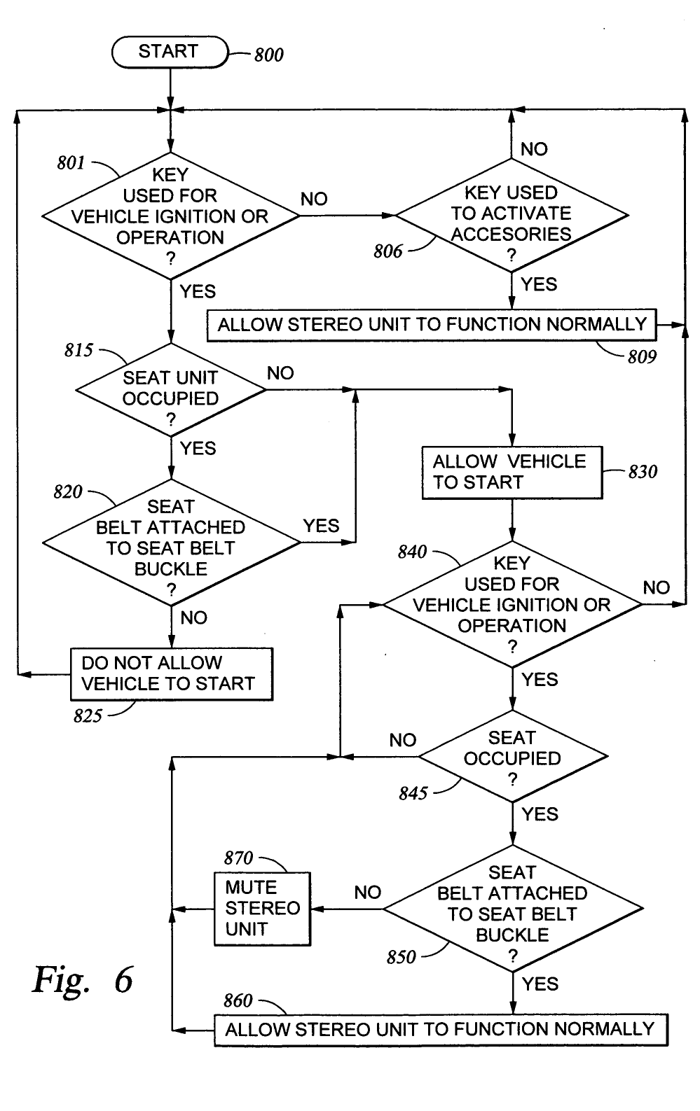

FIG. 6 is a flowchart depicting the interaction between control unit 615 and seat unit 600, starter unit 630, key status sensor 625, and stereo unit 620. As shown in block 801, key status sensor 625 determines if a key is being used for vehicle ignition or operation. Thus, key status sensor 625 may indicate if the key is used for vehicle ignition or operation. If the key is not being used for vehicle ignition or operation, key status sensor 625 determine if the key is being used to activate accessories. Thus, key status sensor 625 may indicate if the key is used to activate accessories as shown in block 806. If the key is not used to activate accessories, the process may start over at block 800. If the key is used to activate accessories, control unit 615 allows stereo unit 625 to function normally as shown in block 809.

If the key is used for vehicle ignition or operation, control unit 615 checks if seat unit 600 is occupied as shown in block 815. If seat 604 is not occupied, control unit 615 allows starter unit 630 to start the vehicle as shown in block 830. If seat 604 is occupied and seat belt sensor 606 indicates that seat belt 602 is attached to seat belt buckle 603 as shown in block 820, control unit 615 allows starter unit 630 to start the vehicle as shown in block 830. If seat 604 is occupied and seat belt sensor 606 indicates that seat belt 602 is not attached to seat belt buckle 603, control unit 615 does not allow starter unit 630 to start the vehicle as shown in block 825 and the process may start over at block 800.

If control unit 615 allows starter unit 630 to start the vehicle as shown in block 830 and the key is no longer used for vehicle ignition or operation as shown in block 840, the process may start over at block 800. If the key is still used for vehicle ignition or operation, control unit 615 determines if seat 604 is occupied as shown in block 845. If seat 604 is not occupied, control unit 615 checks if the key is still used for vehicle ignition or operation as shown in block 840. If seat 604 is occupied, control unit 615 checks if seat belt 602 is attached to seat belt buckle 603 as shown in block 850.

If seat belt 602 is attached to seat belt buckle 603, control unit 615 allows stereo unit 620 to function normally as shown in 860. If seat belt 602 is not attached to seat belt buckle 603, control unit 615 mutes stereo unit 620 as shown in block 870. Control unit 615 checks if the key is still used for vehicle ignition or operation as shown in block 840 after muting the stereo unit 870 or allowing the stereo unit to function normally 860. The control unit 615 continues in this loop until the vehicle is turned off in which case the process starts over at block 800.

When a user sits in seat 604 in a vehicle that contains the embodiment of the invention shown in FIG. 5, the vehicle may not start unless the user attaches his seat belt 602 to seat belt buckle 603. Stereo unit 620 may function normally. If the user removes his seat belt 602 after the vehicle has started, control unit 615 may mute stereo unit 620 until the user reattaches seat belt 602 to seat belt buckle 603. Thus, the user is encouraged to keep seat belt 602 attached to seat belt buckle 603 so that stereo unit 620 functions normally.

Accessory mode may allow certain vehicle components, such as stereo unit 620, to be used without starting the vehicle. In accessory mode, accessories in the vehicle may be operated if the user does not attach seat belt 602 to seat belt buckle 603. In some embodiments of the invention, as shown in FIG. 5, the vehicle may be started if a user is not sitting in seat 604. This feature may be desirable for emergency situations (e.g., seat belt sensor 606 malfunctions or breaks) or when the user needs to let the vehicle's engine warm up on a cold day. For example, if the user turns on the vehicle without sitting on seat 604, the vehicle may idle and the engine may warm up to suitable levels. The user may move indoors to stay warm while the vehicle warms up.

The system shown in FIG. 5 may contain multiple seat units 600 coupled to control unit 615. The interaction between control unit 615, seat units 600, starter unit 630, stereo unit 620, and key status sensor 625 may be similar to the flowchart shown in FIG. 6. Thus, if any seats are occupied and one or more of the corresponding seat belts are not attached to the corresponding seat belt buckle, the vehicle may not start. Once the vehicle has started, control unit 615 may mute stereo unit 620 if a seat belt of an occupied seat unit detaches from the corresponding seat belt buckle. Once the seat belt in question is attached to the corresponding seat belt buckle, stereo unit 620 may return to normal functionality.

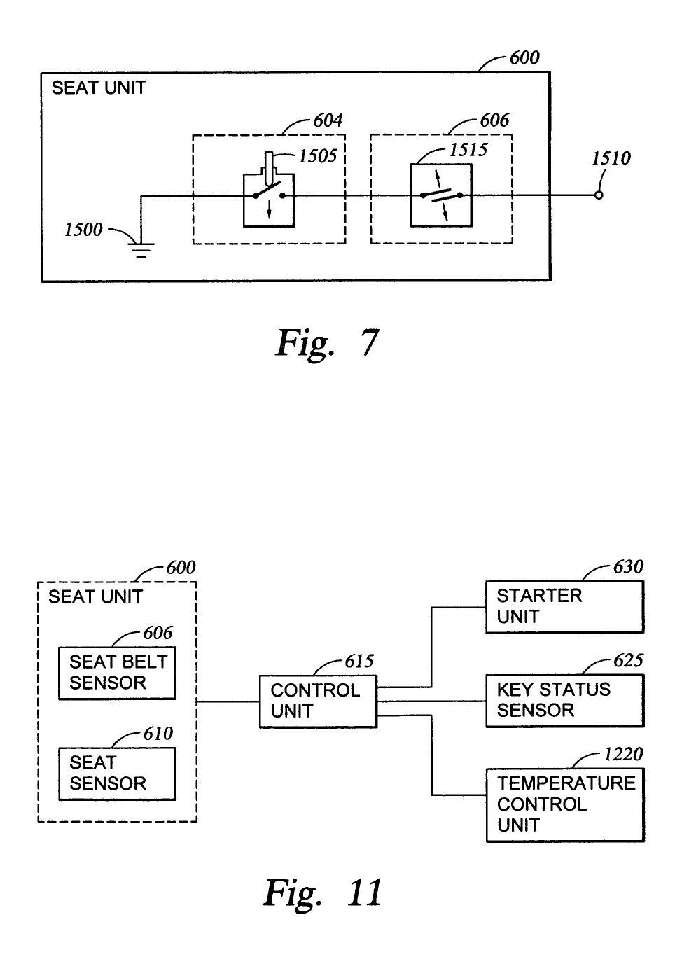

Turning now to FIG. 7, in some embodiments of the invention, a circuit implementation in seat unit 600 contains seat sensor 604 coupled to a seat belt sensor 606 and a ground connection 1500. Ground connection 1500 represents a connection to a negative terminal of a battery (not shown). Seat belt sensor 606 further couples to a seat unit output 1510 which may further couple to control unit 615 as shown in FIG. 5. Seat sensor 604 may consist of a push button switch 1505 that is normally open when the seat is not occupied. Seat belt sensor 606 may consist of a tension switch 1515 that is normally closed when seat belt 602 is not attached to seat belt buckle 603.

When a user sits on seat 604, push button switch 1505 closes. If tension switch 1515 remains closed (i.e. the seat belt is not attached to seat belt buckle) when push button switch 1505 closes, push button switch 1505 completes a circuit in seat unit 600. Current flows from ground connection 1500 to seat unit output 1510 and further to control unit 615, thus indicating to control unit 615 that seat unit 600 is occupied and seat belt 602 is not attached to seat belt buckle 603. If a user sitting in seat 604 attaches seat belt 602 to seat belt buckle 603, tension switch 1515 opens the circuit in the seat belt sensor 606. Thus, no current flows from ground connection 1500 to seat unit output 1510 and further to control unit 615, indicating to control unit 615 that seat unit 600 is occupied and seat belt 602 is attached to seat belt buckle 603.

FIG. 8, in accordance with some embodiments of the invention, shows control unit 615 connected to a hood status unit 910, starter unit 630, stereo unit 620, front passenger seat unit 915, drivers seat unit 916, ground connection 1500, and positive 12 volt connection 925 by single lines to pins 8 908, 7 907, 6 906, 5 905, 4 904, 3 903, 2 902, and 1 901, respectively, of a main connector unit (MCU) 930. The aforementioned single lines may be attached together by a Molex® harness or any device that may organize and order the wires. Also, a protective case 909 surrounding control unit 615 may be made of plastic, fiberglass, or any other material that may protect the interior circuitry.

Control unit 615 contains electronic circuitry capable of receiving signals from the peripheral units, such as the key status sensor 925, hood status unit 910, and so on, and controlling stereo unit 620 and starter unit 630. A battery 940 includes positive 12 volt connection 925 and ground connection 1500. Key status sensor 625 connects to positive 12 volt connection 925 and contains a switch that is normally open. When key status sensor 625 detects that a key is used for vehicle ignition or operation, the switch is closed, thereby connecting control unit 615 to positive 12 volt connection 925 through pin 3 and indicating to control unit 615 that the key is being used for vehicle ignition or operation.

Driver seat unit 916 and front passenger seat unit 915 both connect to ground connection 1500 as shown in FIG. 7. Control unit 615 is connected to ground connection 1500 through pin 4 904 or pin 5 905 when at least one of the seat units is occupied and the seat belt of the seat unit is not securely fastened. Thus, control unit 615 is alerted when one of the seat units is occupied and a seat belt is not secured.

Hood status unit 910 connects to ground connection 1500 and contains a switch that is open in its normal state when the hood is closed. If a hood of the vehicle is raised, the switch is closed, thus connecting pin 8 908 of control unit 615 to ground connection 1500 and indicating to control unit 615 that the hood is raised for maintenance.

Key status sensor 625 may also connect to control unit 615 via pin 3 953 of an auxiliary connector unit (ACU) 953. Multiple rear seat units (961, 962, 963, 964) may connect to control unit 615 via pin 1 951 and pin 2 952 of auxiliary connector unit 953. Each rear seat unit connects to ground connection 1500 as shown in FIG. 7. Pin 1 951 or pin 2 952 may connect to ground connection 1500 through a rear seat unit if the rear seat units is occupied and the seat belt of the rear seat unit is not securely fastened, thus indicating to control unit 615 that the seat belt of an occupied seat is not fastened.

Each rear seat unit connects to control unit 615 through a diode (970, 971, 972, 973). The diodes isolate each rear seat unit and prevent undesired current interaction between seat units. The cathode (−) of each diode connects to seat unit output 1510 of each rear seat unit. The anode (+) of each diode connects to control unit 615. More rear seat units may connect to pin 1 951 and pin 2 952 through additional diodes.

The wires coupled to auxiliary connector unit 935 may be attached together via a Molex® harness or any device that may organize and order the wires. In some embodiments of the invention, one or more fuses may be connected between battery 940 and control unit 615 to protect against excessive current flow. In some other embodiments of the invention, the seat unit output 1510 shown in FIG. 7 of each rear seat unit may connect to both pin 1 951 and pin 2 952 of ACU 935 through additional diodes (not shown). Thus, if one of the seat units is occupied and the seat belt of the seat unit is not securely fastened, the seat unit may connect both pin 1 935 and pin2 952 to ground connection 1500.

If a key is used for vehicle ignition and one of the seat units in FIG. 8 connects control unit 615 to ground connection 1500, which indicates that the seat unit is occupied and the seat belt is not attached to the seat belt buckle, current may flow from control unit 615 through pin 7 907 to starter unit 630. Starter unit 630 may not allow the vehicle to start if the starter unit is receiving current from control unit 615. Current may also flow from control unit 615 through pin 6 906 to stereo unit 620 if one of the seat units connects control unit 615 to ground connection 1500. Stereo unit 620 may be muted or limited in functionality if current is received from control unit 615.

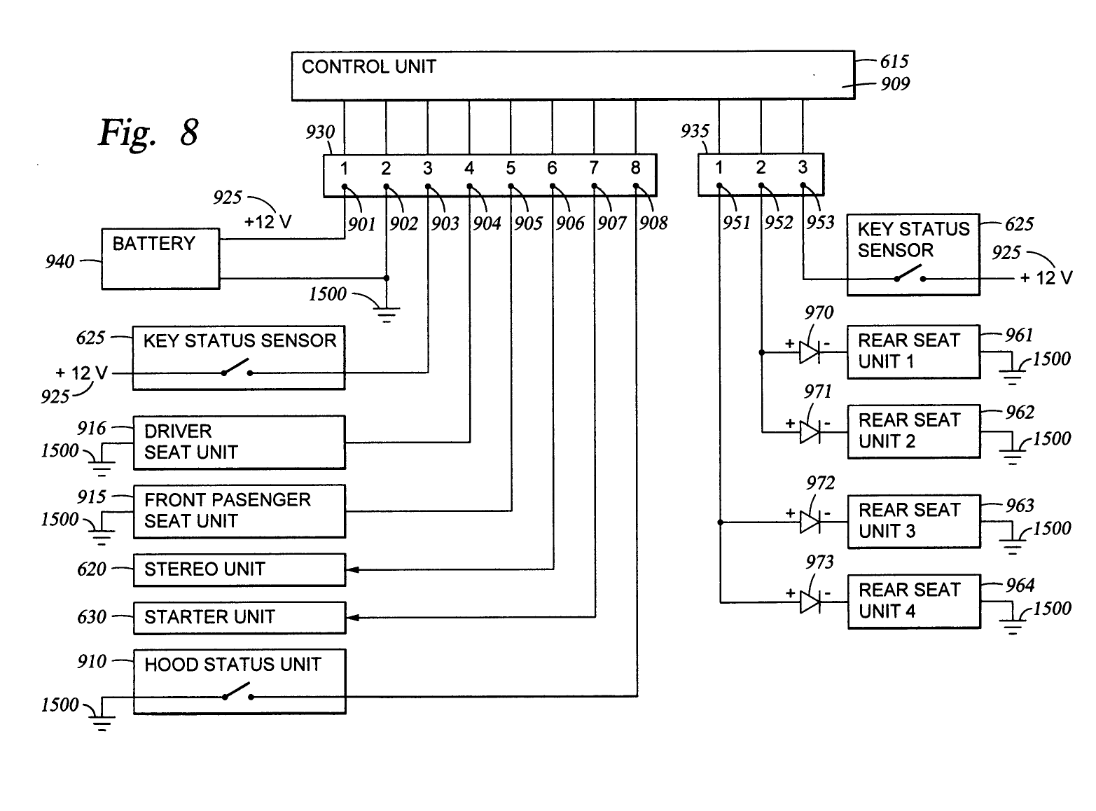

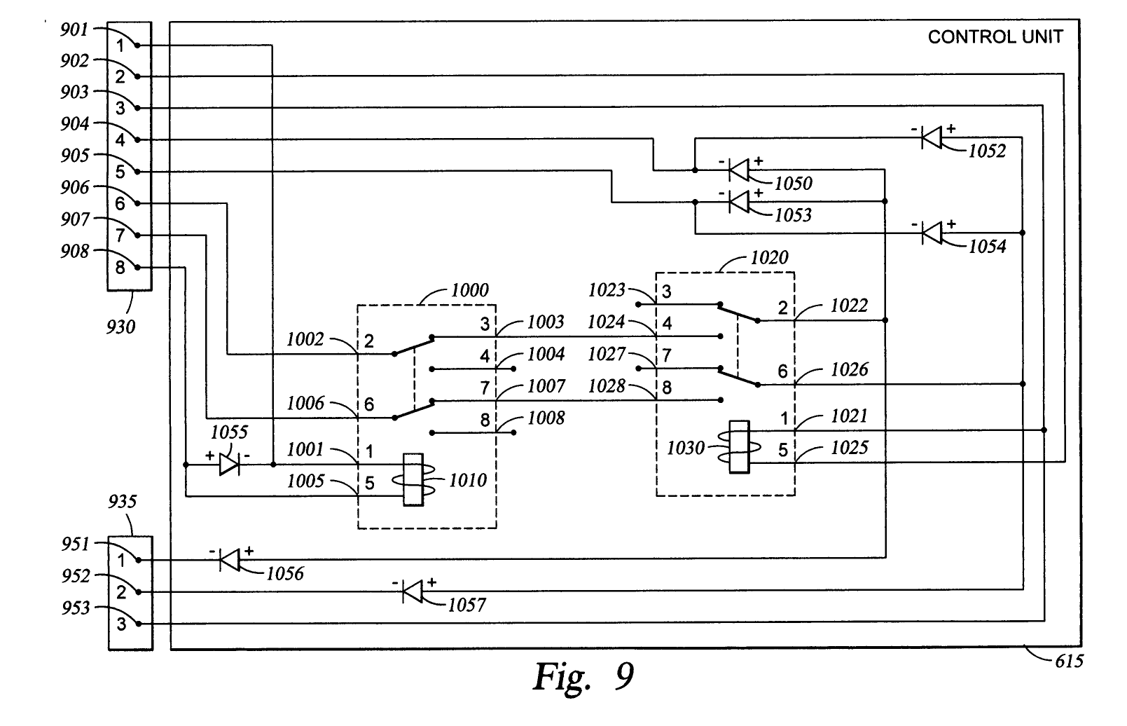

Referring now to FIG. 9, a circuit implementation of control unit 615 comprises a first relay unit 1000 and second relay unit 1020 coupled together and both coupled between MCU 930 and ACU 935. First and second relay units (1000, 1020) may be NEC® Miniature Signal Relays or any relay devices that perform as described below. Pin 3 1003 of first relay unit 1000 connects to pin 4 of second relay unit 1020, and pin 7 1007 of first relay unit 1000 connects to pin 8 1028 of second relay unit 1020. Pin 4 1004 and pin 8 1008 of first relay unit 1000 and pin 3 1023 and pin 7 1027 of second relay unit 1020 are not connected to components of control unit 615.

Pin 2 1002 of first relay unit 1000 connects to stereo unit 620 (not shown in FIG. 9) through pin 6 906 of MCU 930. Pin 6 1006 of first relay unit 1000 connects to starter unit 630 (not shown in FIG. 9) through pin 7 907 of MCU 930. Pin 1 1001 of first relay unit 1000 connects to pin 1 901 of MCU 930 and further to positive 12 volt connection 925 (not shown in FIG. 9). Pin 5 1005 of first relay unit 1000 connects to pin 8 908 of MCU 930 and further to hood status unit 910 (not shown in FIG. 9). Also, a first diode 1055 couples between pin 1 1001 and pin 5 1005. The anode (+) of diode 1055 couples to pin 5 1005 and the cathode (−) of diode 1055 couples to pin 1 1001. Diode 1055 may eliminate current transients in a control coil 1010 in first relay unit 1000.

Pin 2 1022 of second relay unit 1020 connects through a second diode 1050 to pin 4 904 of MCU 930 and further to drivers seat unit 916 (not shown in FIG. 9), through a third diode 1053 to pin 5 905 of MCU 930 and further to front passenger seat unit 915 (not shown in FIG. 9), and through a fourth diode 1056 to pin 1 951 of ACU 935 and further to a plurality of rear seat units (not shown in FIG. 9). Pin 6 1026 of second relay unit 1020 also connects through a fifth diode 1052 to pin 4 904 of MCU 930 and further to drivers seat unit 916 (not shown in FIG. 9), through a sixth diode 1054 pin 5 905 of MCU 930 and further to front passenger seat unit 915 (not shown in FIG. 9), and through a seventh diode 1057 to pin 2 952 of ACU 935 and further to a plurality of rear seat units (not shown in FIG. 9). Pin 1 1021 of second relay unit 1020 connects to pin 3 903 of MCU 930 and further to key status sensor 625 (not shown in FIG. 9) and pin 3 953 of ACU 935 and further to key status sensor 625 (not shown in FIG. 9). Pin 5 1025 of second relay unit 1020 connects to pin 2 902 of MCU 930 and further to ground connection 1500 (not shown in FIG. 9).

When first relay unit 1000 is inactive (i.e. no current is flowing through control coil 1010), pin 3 1003 connects to pin 2 1002 and pin 7 1007 connects to pin 6 1006. Control coil 1010 couples between pin 1 1001 and pin 5 1005. First relay unit 1000 may activate when current flows through control coil 1010 and creates a magnetic field. The magnetic field enables first relay unit 1000 to connect pin 4 1004 to pin 2 1002 and pin 8 1008 to pin 6 1006.

When second relay unit 1020 is inactive, pin 3 1023 connects to pin 2 1022 and pin 7 1027 connects to pin 6 1026. Second relay unit 1020 contains a control coil 1030 coupled between pin 1 1021 and pin 5 1025. Second relay unit 1020 may activate when current flows through control coil 1030 and creates a magnetic field. The magnetic field enables second relay unit 1020 to connect pin 4 1024 to pin 2 1022 and pin 8 1028 to pin 6 1026.

First relay unit 1000 may activate when hood status unit 910 connects pin 8 908 to ground connection 1500, indicating that the hood is open. Thus, current may flow through control coil 1010 through pin 1 901 to positive 12 volt connection 925 (not shown in FIG. 9) and activate control coil 1010. Second relay unit 1020 may activate when the key status sensor 625 switch is closed, which indicates that the key is used for vehicle ignition or operation, and key status sensor 625 connects pin 3 903 or 953 to a positive 12 volt connection 925. Thus, current may flow from ground connection 1500 through pin 2 902 to control coil 1030 and further through the closed switch of key status sensor 625 to positive 12 volt connection 925 to activate control coil 1030.

When first relay unit 1000 is inactive and second relay unit 1020 is inactive, the stereo unit 620 functions normally. If first relay unit 1000 is inactive and second relay unit 1020 is active, the vehicle may not be started if one of the seat unit outputs connects to ground 1500, which may indicate that a seat unit 600 is occupied and seat belt 602 is not attached to seat belt buckle 602 as described above. If the vehicle has started and one of the seat unit outputs connects to ground 1500, stereo unit 620 may be muted.

If first relay unit 1000 is activated, which may indicate that the hood is open for maintenance, the vehicle may start and stereo unit 620 may operate normally regardless of the status of the seat units in the vehicle.

In some embodiments of the invention, a diode (not shown in FIG. 9) may couple between pin 1 1021 and pin 5 1025 of second relay unit 1020. The diode may eliminate current transients in control coil 1030 in second relay unit 1020.

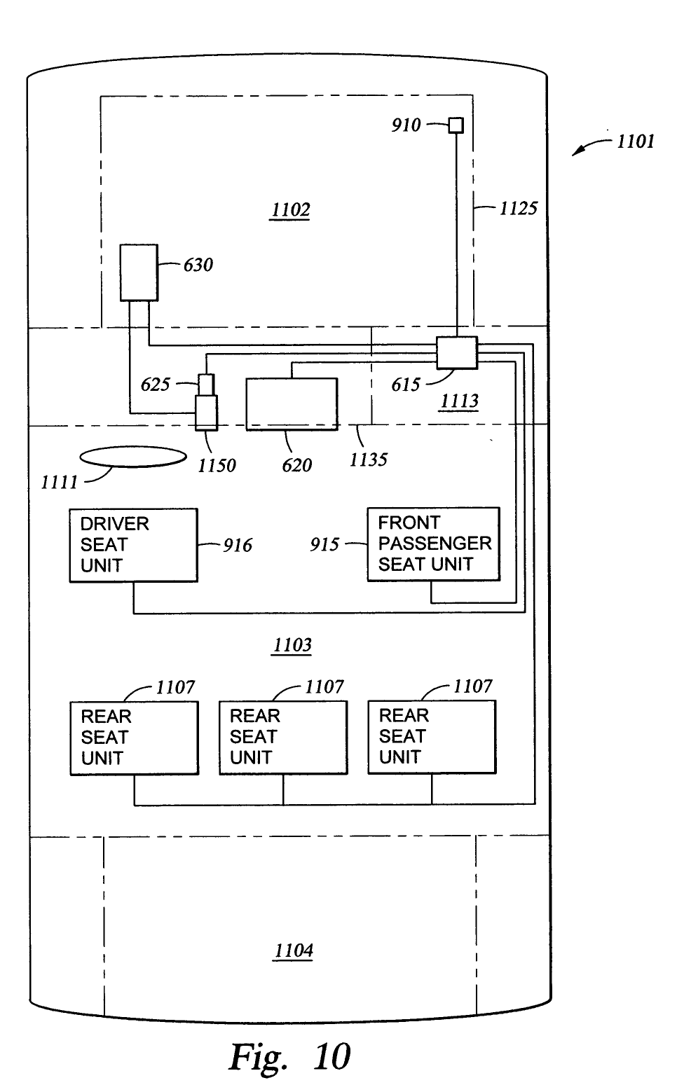

Turning now to FIG. 10, an automobile system 1101 contains control unit 615 and the peripheral units shown in FIG. 8. In some embodiments of the invention, automobile system 1101 may be a sedan, a truck, or any type of automobile having multiple rows of seats. Automobile system 1101 may comprise a front section 1102, passenger section 1103, and back section 1104. Front section 1102 may comprise a hood 1125 and hood status unit 910. Hood 1125 may be a protective lid covering front section 1102 of automobile system 1101 and may protect automobile components found in front section 1102 such as an engine, transmission, and so on (not shown). Hood status unit 910 may detect if hood 1125 is open for maintenance of automobile system 1101.

Passenger section 1103 may comprise a drivers seat unit 916, a front passenger seat unit 915, and a plurality of rear seat units 1107. Front passenger seat unit 915 and drivers seat unit 916 may be attached together. Also, the plurality of rear seat units 1107 may be attached together. Each seat unit may be similar to seat unit 600 in FIG. 4.

Passenger section 1103 may further comprise a steering wheel 1111, stereo unit 620, and a glove compartment 1113 attached to a dashboard unit 1135. Dashboard unit 1135 may be a panel extended from the intersection of front section 1102 and passenger section 1103. Steering wheel 1111 may be any device used for steering a vehicle. Key status sensor 625 attaches to steering wheel 1111 (attachment not shown in FIG. 10) and may couple to an ignition device 1150. As described above, key status sensor 625 may detect if a key has been placed in ignition device 1150, if the key is in the ignition position, or if the key is in the accessory position. Starter unit 630 and key status sensor 625 couple to control unit 615. Starter unit may start automobile system 1101. Stereo unit 620 may attach to dashboard unit 1135 or may be located anywhere in automobile system 1101.

Glove compartment unit 1113 may be located in the automobile system 1101 in dashboard 1135 near front passenger seat unit 915. In some embodiments of the invention, control unit 615 may be located in or behind glove compartment unit 1113. Control unit 615 may couple to key status sensor 625, stereo unit 620, hood status unit 910, and the seat units. Control unit 615 may alternatively be located in dashboard 1135 or anywhere else in automobile system 1101.

Automobile system 1101 functions as described above for the system of FIG. 8. For example, a driver may sit in drivers seat 916 and place a key in ignition device 1150. If the driver attaches seat belt 602 to seat belt buckle 603 of drivers seat unit 916, the driver may start the vehicle and stereo unit 620 functions normally. Stereo unit 620 functions normally as long as seat belt 602 is attached to seat belt buckle 603.

In accordance with some other embodiments of automobile system 1101, a driver, a passenger, and some cargo may be in drivers seat unit 916, rear seat unit 1107, and front passenger seat unit 915, respectively. The driver may be a mother driving her son, who is the passenger, and a bag of groceries, the cargo, back from a store. The mother may sit in drivers seat unit 916 and secure her seat belt. The child may sit in rear seat unit 1107 and may not secure his seat belt. Control unit 615 may not allow automobile system 1101 to start and thus may alert the mother that the child's seat belt 602 is not attached to the seat belt buckle 603.

Once the child has secured his seat belt, the mother once again turns her key in ignition device 1150 to the ignition position. Control unit 615 may not allow automobile system 1101 to start because the bag of groceries in front passenger seat unit 915 is not secure. The mother may attach seat belt 602 to seat belt buckle 603 in front passenger seat unit 915 to secure the cargo, or she may place the sack of groceries in back section 1104 of the vehicle. The weight sensitivity in seat sensor 610 of each seat unit may alert drivers and passengers of unsecured objects occupying seat units of automobile system 1101. Loose objects in a vehicle may lead to injuries in the event of an accident. In some other embodiments of the invention, seat units in automobile system 1101 may be configured to alert control unit 615 only if the weight of a human being is detected.

Once the bag of groceries has been properly stored in automobile system 1101 and the mother and son's seat belts secured, control unit 615 may allow automobile system 1101 to start. Stereo unit 620 may have normal functionality. If the son removes his seat belt 602 from seat belt buckle 603, stereo unit 620 may mute, thus alerting the mother that the son has removed his seat belt. The child must secure his seat belt in order to return normal functionality to stereo unit 620, thereby encouraging him to wear his seat belt.

In accordance with some other embodiments of automobile system 1101, automobile system 1101 may be in a garage for maintenance. A mechanic may need to start automobile system 1101 while examining under hood 1125. When the mechanic lifts hood 1125, hood status unit 1126 alerts control unit 615 that maintenance may be occurring. Control unit 615 may allow starter unit 630 to start automobile system 1101 regardless of the status of the seat units.

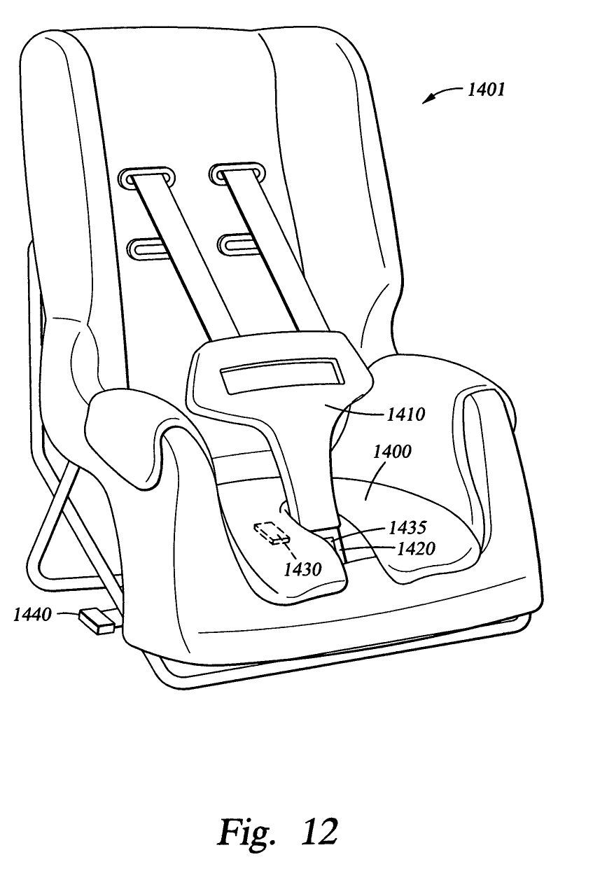

Turning to FIG. 11, control unit 615 couples to seat unit 600, starter unit 630, key status sensor 625, and a temperature control unit 1220. In some embodiments of the invention, temperature control unit 1220 may be capable of adjusting temperature inside a vehicle to uncomfortable levels if control unit 600 detects seat 604 is occupied and seat belt 602 is not attached to seat belt buckle 603. For example, if a driver driving a vehicle including the system shown in FIG. 12 removes his seat belt, temperature control unit 1220 may activate the vehicle's heater. The increase in temperature inside the vehicle may encourage the driver to secure his seat belt and discourage him from removing his seat belt in the future.

In some embodiments of the invention, the system shown in FIG. 11 may function with the stereo-muting system shown in FIG. 5. The system shown in FIG. 11 may be useful for handicapped persons who may not be able to perceive muting of a stereo or for individuals who may not listen to a stereo or CD player when driving.

Referring to FIG. 12, a child seat unit 1401 comprises a child sitting device 1400 attached to a child restraint device 1410 and a child restraint device buckle 1420. Child restraint device 1410 may be a 6-point harness, a 5-point harness, an overhead shield, a t-shield, or any device that may restrain a child. A child may be placed on child sitting device 1400, and child restraint device 1410 may attach to child restraint device buckle 1420 to secure the child. A child seat sensor 1430 may be located in child sitting device 1440 and may detect when child sitting device 1400 is occupied. A child restraint device sensor 1435 may be located within child restraint device buckle 1420, and may detect when child restraint device 1410 attaches to child restraint device buckle 1420.

Child restraint device sensor 1435 and the child seat sensor 1430 may be coupled to a system interface connector 1440. System interface connector 1440 may couple to control unit 615 shown in FIG. 8. Thus, system interface connector 1440 may connect to control unit 615 through a diode like 970-973 to pin 1 951 or pin 2 952. Thus, if child seat unit 1401 is occupied and child restraint device 1410 is not attached to child restraint device buckle 1420, control unit 615 may mute stereo unit 620 or prevent starter unit 630 from starting the vehicle.

Child seat unit 1401 shown in FIG. 12 in combination with the embodiment of the invention shown in FIG. 8 may provide two layers of restraint protection for a child in child seat unit 1401. In some embodiments of the invention, the child seat unit is attached to a seat in a vehicle by a seat belt. For example, child seat unit 1401 may be placed in rear seat unit 4 964 and system interface connector 1440 may connect to pin 1 935 of control unit 615. If the child seat unit 1401 is not attached securely to rear seat unit 4 964 using the seat belt, control unit 615 will not allow the vehicle to start or may mute the stereo unit if already started. Additionally, the control unit will not allow the vehicle to start or mute the stereo unit if the child seat unit 1401 is occupied and the child restraint device is not secure. Thus, a driver or passenger may be alerted and the child seat unit 1401 may be secured to ensure safe travel for the child.

The seat belt system described above may encourage vehicle drivers and passengers to use seat belts. By limiting entertainment and comfort features in a vehicle if a user is not wearing a seat belt, users may use a seat belt.

While the present invention has been described with respect to a limited number of embodiments, those skilled in the art will appreciate numerous modifications and variations therefrom. By way of example, a vehicle may be an automobile as described above or any other mechanized conveyance such as a boat, airplane, train, bus, motorcycle, three-wheeled bicycle, and so on that transports people. It is intended that the appended claims cover all such modifications and variations as fall within the true spirit and scope of this present invention.

What is claimed is:

1. A method for encouraging use of a restraint device in a vehicle, comprising:
detecting if a restraint device in a seat unit is attached to a receiving device; and
allowing a comfort unit to function normally if the restraint device of the seat unit is attached to the receiving device of the seat unit.

2. The method of claim 1, wherein the seat unit is a child seat unit.

3. The method of claim 1, comprising allowing the comfort unit to function normally if the vehicle is in an accessory mode.

4. The method of claim 1, comprising:
detecting if the seat unit occupied; and
allowing the comfort unit to function normally if the seat unit occupied.

5. The method of claim 4, comprising allowing the vehicle to start if the seat unit is occupied and the restraint device of the seat unit is attached to the receiving device of the seat unit.

6. The method of claim 5, wherein the vehicle is capable of starting if a drivers seat unit is not occupied.

7. The method of claim 5, comprising allowing the vehicle to start if the hood of the vehicle is raised.

8. The method of claim 5, wherein the comfort unit is a temperature control unit capable of adjusting the temperature inside the vehicle or an entertainment unit.

9. The method of claim 8, wherein adjusting the temperature inside the vehicle further comprises adjusting the temperature inside the vehicle to a level uncomfortable for a human being if the seat unit is occupied and the restraint device of the seat unit is not attached to the receiving device.

10. The method of claim 8, comprising limiting the functionality of the entertainment unit if the seat unit is occupied and the restraint device of the seat unit is not attached to the receiving device.

11. The method of claim 10, wherein limiting the functionality of the entertainment unit further comprises muting the entertainment unit.

12. An apparatus for encouraging use of a restraint device in a vehicle, comprising:
at least one seat unit;
a control unit coupled to the at least one seat unit; and
a comfort unit coupled to the control unit, wherein said control unit is capable of controlling the functionality of said comfort unit.

13. An apparatus of claim 12, wherein the comfort unit is an entertainment unit or a temperature control unit capable of adjusting a temperature inside the vehicle.

14. The apparatus of claim 13, wherein controlling the functionality of said entertainment unit further comprises muting the entertainment unit.

15. The apparatus of claim 13, wherein the entertainment unit is selected from the group consisting of a stereo, a radio, a tape player, a CD player, an MP3 player, an MP3 CD player, a DVD player, a display monitor, multiple display monitors, a speaker, multiple speakers, a navigation system, a computer, and a video game device.

16. The apparatus of claim 12, wherein the at least one seat unit is a child seat unit.

17. The apparatus of claim 16, wherein the child seat unit further comprises:
a child sitting device;
a receiving device attached to the child sitting device;
a child restraint device attached to the child sitting device, said child restraint device capable of attaching to the receiving device;
a restraint sensor attached to the child restraint device, wherein the restraint sensor is capable of detecting if the child restraint device is detached from the receiving device;
a child seat sensor attached to the child sitting device, wherein the child seat sensor is capable of detecting if the child sitting device is occupied; and
a system interface device coupled to the child seat sensor and the restraint device sensor, wherein the system interface device is capable of communicating with the control unit.

18. The apparatus of claim 17, wherein the system interface device informs the control unit if the child sitting device is occupied and the child restraint device is detached from the receiving device.

19. The apparatus of claim 12, wherein the seat unit comprises:
a device for sitting attached to the vehicle;
a receiving device attached to the vehicle;
a restraint device attached to the vehicle, wherein the restraint device is capable of attaching to the receiving device; and
a restraint sensor attached to the restraint device and coupled to the control unit, wherein the restraint sensor is capable of indicating to the control unit if the restraint device is detached from the receiving device.

20. The apparatus of claim 19, wherein the device for sitting is selected from the group consisting of a seat, a captain's chair, a bucket seat, and a bench seat.

21. The apparatus of claim 19, wherein the restraint device is a seat belt and the receiving device is a seat belt buckle.

22. The apparatus of claim 19, wherein the seat unit further comprises:
a seat sensor attached to the device for sitting, wherein said seat sensor is coupled to the control unit; and
wherein the seat sensor is capable of indicating to the control unit if the device for sitting is occupied.

23. The apparatus of claim 22, comprising:
a battery including a terminal, wherein the terminal is coupled to the seat sensor;
a pushbutton switch in the seat sensor that is normally in an open state if the device for sitting is not occupied; and
a tension switch in the restraint sensor that is normally in a closed state if the restraint device is detached from the receiving device.

24. The apparatus of claim 12, comprising:
a hood device attached to the vehicle;
a hood status unit coupled to the control unit, wherein the hood status unit is capable of indicating to the control unit if the hood device is raised;
a starter unit coupled to the control unit, wherein the starter unit is capable of allowing the vehicle to start;
a key status sensor coupled to the control unit, wherein the key status sensor is capable of indicating to the control unit if a key is used for vehicle ignition;
an entertainment unit coupled to the control unit, wherein the control unit is capable of operating the entertainment unit; and
a battery coupled to the control unit, wherein the battery further comprises a positive terminal coupled to the control unit and a negative terminal coupled to the control unit.

25. An apparatus of claim 24, wherein the control unit further comprises:
a first relay unit coupled to the negative terminal of the battery, entertainment unit, positive terminal of the battery, starter unit, hood status unit, and the at least one seat unit; and
a second relay unit coupled to the first relay unit, wherein the second relay unit couples to the at least one seat unit, the key status sensor, and the negative terminal of the battery.

26. The apparatus of claim 12, wherein the control unit couples to the comfort unit and the at least one seat unit through a databus connection.
